(19) United States
(12) Patent Application Publication
(10) Pub. No.: US 2006/0074699 A1
(43) Pub. Date: Apr. 6, 2006

(54) System and method for processing mass action litigation on a jurisdictionally dispersed basis through geographically dispersed personnel and automated data systems

(76) Inventors: Brett M. Samsky, Atlanta, GA (US); Steve Stewart, Las Vegas, NV (US); Jason S. Williams, Braselton, GA (US); Wagner Longo de Castro, Sao Paulo (BR); Daniel Lois Greco, Sao Paulo (BR)

Correspondence Address: NEEDLE & ROSENBERG, P.C., SUITE 1000, 999 PEACHTREE STREET, ATLANTA, GA, 30309-3915, US

(21) Appl. No.: 10/941,306

(22) Filed: Sep. 15, 2004

(51) Int. Cl. G06Q 99/00; H04L 9/00

(52) U.S. Cl. 705/1; 705/80

(57) ABSTRACT

A system and method whereby similarly situated plaintiffs can efficaciously process a large volume of legal actions requiring mass customization and standardization in a narrow legal area against similarly situated defendants on an unconsolidated case by case basis (or “Mass Action Litigation”) through a technologically and organizationally unified operational structure. The present invention joins the specificity and craft of the legal profession with a business process support structure through technology and standardization of policies and processes to enable Mass Action Litigation. In each distinct class of Mass Action Litigation, an automated rule based decision engine pushes individual instances of litigation through an instance specific lifecycle workflow contemplated on a jurisdictionally specific basis to achieve an optimum result. The present invention organizes the legal professionals who participate in Mass Action Litigation into economically optimized sets of attorneys operating collectively through a single organizational unit. Each attorney is connected to the supporting business process support structure through a web enabled expert system that provides a single source of data, the decision engine, and an engine to allocate business processes amongst the most efficient party, be it an automated process, a legal professional, or a member of the business process support structure. The business process support structure is likewise connected to each attorney through the web enabled expert system. The narrow legal areas of each Mass Action Litigation class permits optimization of the lifecycle process workflow relative to each individual instance of litigation such that as the volume of Mass Action Litigation increases, the percentage of work completed by the business process support structure approaches 100%.

### BACKGROUND AND SUMMARY OF THE INVENTION

1. Field of the Invention

The present invention relates to a standardized system and method for processing Mass Action Litigation (meaning the efficacious processing by similarly situated plaintiffs of a large volume of legal actions requiring mass customization and standardization in a narrow legal area against similarly situated defendants on an unconsolidated case by case basis) on a jurisdictionally dispersed basis (meaning dispersed across a plurality of legal divisions, including, but not limited to: (i) states, (ii) counties, (iii) courts, or (iv) judges), for relatively low value disputes, through geographically dispersed personnel and automated data systems (hereinafter referred to as “National Legal System”).

2. Background of the Invention

Civil litigation (hereafter, “litigation”) is a legal method by which disputes may be resolved. Litigation is an effective and unique means of resolving disputes. The prevailing party in a legal action obtains a judgment or enforceable order from a governing authority with jurisdiction over the losing party, which entails a right of enforcement against the losing party that in effect permits the prevailing party to exercise the governing authority's policy power by proxy through various means such as injunction, garnishment, lien, and levy.

Litigation provides an effective end to dispute resolution; however, the means to the end are cumbersome, slow, and expensive using existing processes. In addition, litigation requires a specialized body of expert knowledge that is, to a significant extent, compartmentalized on a jurisdictional basis, which creates significant difficulties for parties desiring to pursue Mass Action Litigation.

The effectiveness of litigation makes it desirable for dispute resolution. The fact that litigation provides an inefficient means to that end in certain contexts has traditionally limited wider use of litigation as a remedy, particularly in contexts that would qualify as Mass Action Litigation; i.e., litigation is not efficient in fact patterns where a high volume of litigation in a narrow legal area, by similarly situated plaintiffs against large numbers of similarly situated defendants, on an unconsolidated and jurisdictionally dispersed basis, for relatively low value disputes, is required to achieve the end provided by litigation.

Some of the shortcomings of the traditional means to the end provided by litigation have been addressed through applied technological applications and systems. The initial revolution was provided by the typewriter and carbon paper. This manual system has been largely superseded by the development of computer based word processing and data management tools developed to support litigation. While these systems have arguably increased the efficiency of the means to the end provided by litigation, they address neither the jurisdictionally compartmentalized expert knowledge required for litigation nor the challenges inherent in controlled and efficient processing of high volumes of litigation on a jurisdictionally dispersed basis.

The latter two limitations are being addressed today in state of the art products in the marketplace that: (i) integrate business rules relevant to litigation in manual, automated, or hybrid workflow based systems; and (ii) connect dispersed parties via electronic data transmission to third party systems or provide remote access to the host system. While the state of the art attempts to addresses these concerns, it is lacking relative to the issue of controlled and efficient processing of high volumes of litigation. For example, current methodologies do not readily incorporate the optimizations available via skills based business process component segmentation or contemplate low cost/high skilled sourced labor pools (hereinafter referred to as “Business Process Allocation”). Controlled processing of high volumes of litigation with Business Process Allocation is the foundation required for efficient prosecution of Mass Action Litigation.

The concept of Business Process Allocation, predicated on an exponentially increasing level of specialization, is enabled by increasing volumes of litigation (which directly allows for greater labor specialization). Thus increasing volumes of litigation catalyzes Business Process Allocation to enable selection of low cost/high skilled sourced labor pools. The framework for Business Process Allocation is provided by systems that permit dispersed parties to work in a coordinated manner.

These and other aspects of the invention will become apparent from the following description of the invention, although variations and modifications may be effected without departing from the spirit and scope of the novel concepts of the disclosure.

3. Summary of the Invention

One embodiment of the present invention provides a method and system for prosecution of litigation in a novel manner. The invention permits similarly situated plaintiffs to efficiently process high volumes of litigation for relatively low value disputes against large numbers of similarly situated defendants in a narrow legal area on an unconsolidated, case by case basis, on a jurisdictionally dispersed basis, for relatively low value disputes.

In operation, a client using the National Legal System transmits to a single service provider an electronic data file containing an agreed upon set of information relative to a set of relatively low value disputes involving a large number of similarly situated defendants, on an unconsolidated and jurisdictionally dispersed basis. The service provider then initiates litigation in the appropriate jurisdiction on behalf of the client using optimally sourced workers through Business Process Allocation to complete substantially all work related to the prosecution of the litigation by providing access to a computer system over the Internet that has specific business process workflows for each step of the process related to the litigation on a jurisdictionally specific basis.

Once the litigation is initiated, all documents and other communications related to the litigation are routed through a centralized fulfillment center and pushed to the appropriate specialized worker over the Internet.

Optimally sourced attorneys approve and review litigation at designated steps in the business process. Attorneys maintain meaningful involvement in each instance of litigation while dedicating a minimal amount of time to each matter. All work related to the litigation that does not require attorney input is completed by non-attorney workers by virtue of Business Process Allocation.

### BRIEF DESCRIPTION OF THE DRAWINGS

The accompanying drawings, which are incorporated in and constitute a part of this specification, illustrate embodiments of the invention, and together with the description, serve to explain the principles of the invention.

FIG. 1 depicts the National Legal System and its components and structure.

FIG. 2 depicts a National Legal System Archetypal claim Flow Diagram, which is a workflow for a consumer credit card debt claim (which is within the class of claims that qualify as Mass Action Litigation).

FIG. 3 depicts a Cross Functional Diagram of FIG. 1 and FIG. 2.

FIG. 4 depicts the Litigation Component Filter.

FIG. 5 depicts the Narrow Legal Area Hierarchical Rules Set.

FIG. 6 depicts the Efficient Data Transfer Sub-element.

FIG. 7 depicts the Transaction Processing Sub-element.

FIG. 8 depicts the Archetypal Configuration of the Technology Infrastructure.

### DETAILED DESCRIPTION OF THE INVENTION

One or more preferred embodiments of the invention are now described in detail below and in the attachments hereto. Referring to the drawings, like numbers indicate like parts throughout the views. As used in the description herein and attachments hereto, the meaning of “a,” “an,” and “the” includes plural reference unless the context clearly dictates otherwise. Also, as used in the description herein and attachments hereto, the meaning of “in” includes “in” and “on” unless the context clearly dictates otherwise. Finally, as used in the description herein and attachments hereto, the meanings of “and” and “or” include both the conjunctive and disjunctive and may be used interchangeably unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

The embodiments described above are given as illustrative examples only. It will be readily appreciated by those skilled in the art that many deviations may be made from the specific embodiments disclosed in this specification without departing from the scope of the invention.

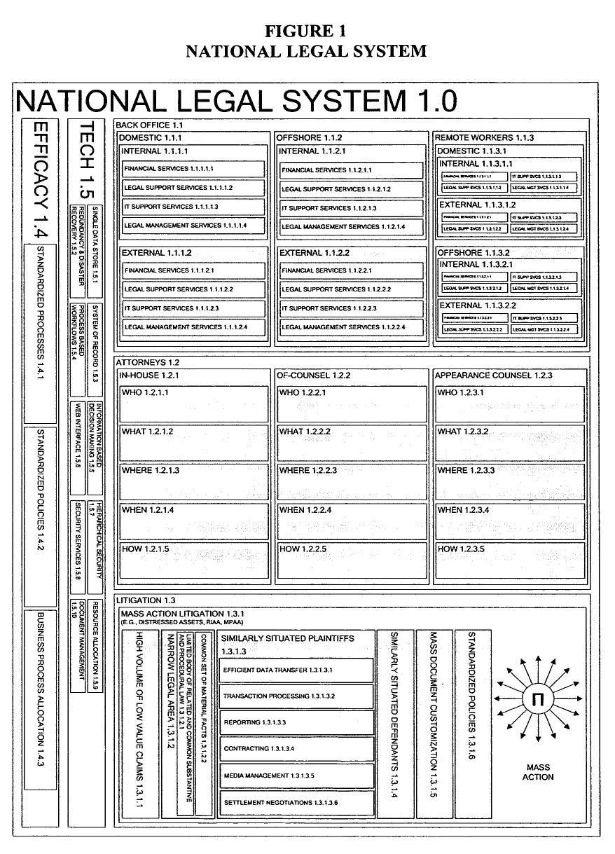

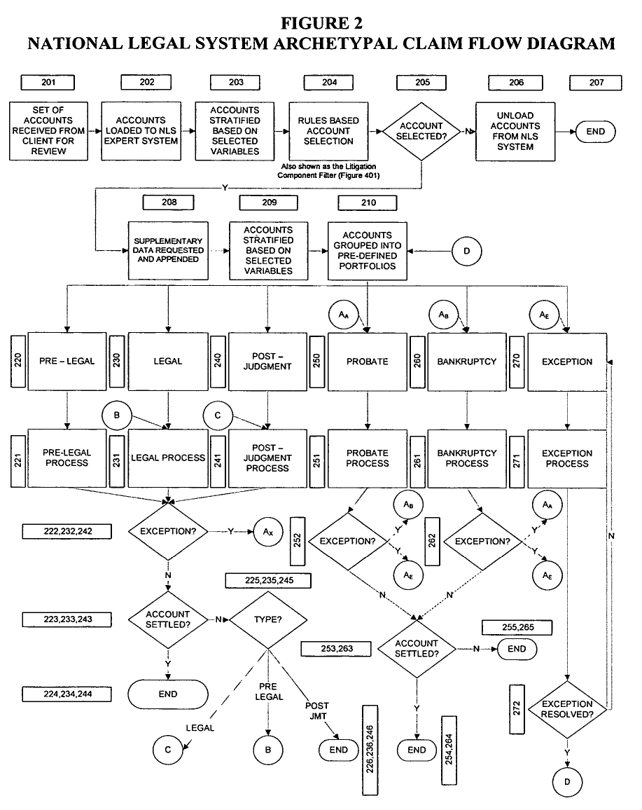

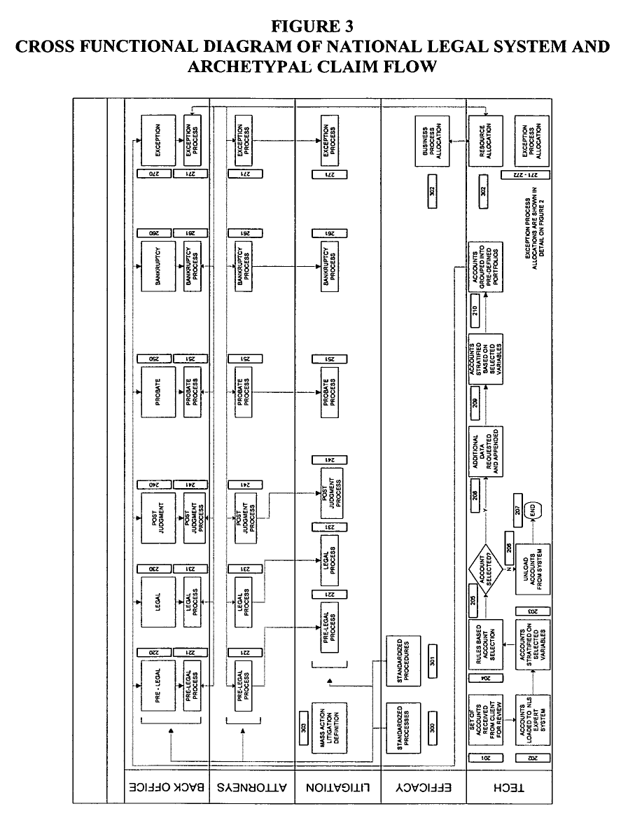

FIG. 1 depicts the components and structure of the invention. A summary of the components and structure is provided by numbered reference. Subsequently FIG. 2 is discussed, presenting the archetypal process of a claim in the context of Mass Action Litigation. Next, FIG. 3 is discussed, presenting the interaction of the components and structure illustrated by FIG. 1 with the archetypal process depicted in FIG. 2. The remaining figures are discussed throughout; however, they primarily provide specific detail as to certain aspects of the invention.

FIG. 1 depicts a hierarchical structure deemed “National Legal System.” The hierarchical scheme is general. Five sub-components are identified in FIG. 1, including: (i) Back Office 1.1; (ii) Attorneys 1.2; (iii) Litigation 1.3; (iv) Efficacy 1.4; and (v) Tech 1.5. The Efficacy 1.4 and Tech 1.5 components should be viewed as providing support to the Back Office 1.1, Attorneys 1.2 and Litigation 1.3 components. The five components comprise the invention when functioning in a coordinated manner. Each component is discussed below in its entirety. As indicated, the interaction of the components is discussed below along with FIG. 3 specifically and generally throughout.

Back Office Component 1.1

FIG. 1 depicts the Back Office sub-component 1.1 of the National Legal System, which in turn has three sub-components. In the context of the invention, the Back Office component 1.1 is one of two components that carry out the work allocated through Business Process Allocation (see infra, “Business Process Allocation 1.4.3”). The work shown in FIG. 2 is allocated between the Back Office component 1.1 (and its three sub-components) and the Attorneys component 1.2 (and its three sub-components). This allocation is facilitated through an automated data system that allocates the work according to the policies and procedures established by the Efficacy component 1.4 and directly through the Tech component 1.5, which provides the connection between the three components depicted as 1.1-1.3 to the Efficacy component 1.4.

The three sub-components of the Back Office component 1.1, which include: (i) Domestic 1.1.1; (ii) Offshore 1.1.2; and (iii) Remote Workers 1.1.3; constitute further application of the principal of Business Process Allocation. Once an element of work is allocated to the Back Office component 1.1, as opposed to the Attorneys component 1.2, it may be further allocated to the correct branch within the Back Office component 1.1 on a skill, cost, quality, or other basis.

Domestic Sub-Component 1.1.1

The Domestic sub-component 1.1.1 constitutes a business unit that is located in the domicile of the entity operating the National Legal System. The Domestic sub-component 1.1.1 has two branches: Internal 1.1.1.1 and External 1.1.1.2. The Internal 1.1.1.1 and External 1.1.1.2 branches of the Domestic sub-component 1.1.1 constitute a further application of Business Process Allocation in order to leverage low cost labor pools with qualified skill sets. The Internal branch 1.1.1.1 represents domestic business processes allocated to the Back Office component 1.1 that are completed internally by employees of the entity operating the National Legal System. The External branch 1.1.1.2 represents domestic business processes allocated to the Back Office component 1.1 that are completed externally by independent contractors to the entity that is operating the National Legal System.

The Internal 1.1.1.1 and External 1.1.1.2 branches of the Domestic sub-component 1.1.1 each contain four leaf nodes that provide the business process support designated. The leaf nodes are ultimately repeated in all branches of the Back Office component 1.1. As a result, the functions of these repetitive leaf nodes are specified only once.

The leaf node Financial Services 1.1.1.1.1, 1.1.1.2.1, 1.1.2.1.1, 1.1.2.2.1, 1.1.3.1.1.1, 1.1.3.1.2.1, 1.1.3.2.1.1, and 1.1.3.2.2.1 represents those business processes relevant to financial operations necessary to support Mass Action Litigation and the National Legal System. These processes include a variety of undeclared child nodes, which include accounts payable, accounts receivable, general ledger, budgeting, tax, forecasting, credit and risk, payroll, and internal financial audit. These functions are replicated under all Financial Services nodes 1.1.1.1.1, 1.1.1.2.1, 1.1.2.1.1, 1.1.2.2.1, 1.1.3.1.1.1, 1.1.3.1.2.1, 1.1.3.2.1.1, and 1.1.3.2.2.1 and work is allocated according to Business Process Allocation. Whether any particular leaf node in Financial Services 1.1.1.1.1, 1.1.1.2.1, 1.1.2.1.1, 1.1.2.2.1, 1.1.3.1.1.1, 1.1.3.1.2.1, 1.1.3.2.1.1, and 1.1.3.2.2.1 actually has work allocated to it is a function of Business Process Allocation; i.e., some leaf nodes may be inactive at any point in time. Activity between leaf nodes in Financial Services 1.1.1.1.1, 1.1.1.2.1, 1.1.2.1.1, 1.1.2.2.1, 1.1.3.1.1.1, 1.1.3.1.2.1, 1.1.3.2.1.1, and 1.1.3.2.2.1 is facilitated by the Efficacy component 1.4 and connected to the remaining sub-components by the Tech component 1.5.

The leaf node Legal Support Services 1.1.1.1.2, 1.1.1.2.2, 1.1.2.1.2, 1.1.2.2.2, 1.1.3.1.1.2, 1.1.3.1.2.2, 1.1.3.2.1.2, and 1.1.3.2.2.2 represents those business processes relevant to providing legal support services to Mass Action Litigation and the National Legal System. These processes include a variety of undeclared child nodes, including outbound document production, inbound document processing, customer service for inbound telephone calls, outbound telephone calls, mail processing, fact investigation, research, and case management. These functions are replicated under all Legal Support Services nodes 1.1.1.1.2, 1.1.1.2.2, 1.1.2.1.2, 1.1.2.2.2, 1.1.3.1.1.2, 1.1.3.1.2.2, 1.1.3.2.1.2, and 1.1.3.2.2.2 and work is allocated according to Business Process Allocation. Whether any particular leaf node in Legal Support Services 1.1.1.1.2, 1.1.1.2.2, 1.1.2.1.2, 1.1.2.2.2, 1.1.3.1.1.2, 1.1.3.1.2.2, 1.1.3.2.1.2, and 1.1.3.2.2.2 has work allocated to it is a function of Business Process Allocation; i.e., some leaf nodes may be inactive at any point in time. Activity between leaf nodes in Legal Support Services 1.1.1.1.2, 1.1.1.2.2, 1.1.2.1.2, 1.1.2.2.2, 1.1.3.1.1.2, 1.1.3.1.2.2, 1.1.3.2.1.2, and 1.1.3.2.2.2 is facilitated by the Efficacy 1.4 component and connected to the remaining sub-components by the Tech component 1.5.

The leaf node IT Support Services 1.1.1.1.3, 1.1.1.2.3, 1.1.2.1.3, 1.1.2.2.3, 1.1.3.1.1.3, 1.1.3.1.2.3, 1.1.3.2.1.3, and 1.1.3.2.2.3 represents those business processes relevant to providing information technology support services to Mass Action Litigation and the National Legal System. These processes include a variety of undeclared child nodes, which include help desk support, network administration, telecommunications support, and data management services. These functions would be replicated under all IT Support Services nodes 1.1.1.1.3, 1.1.1.2.3, 1.1.2.1.3, 1.1.2.2.3, 1.1.3.1.1.3, 1.1.3.1.2.3, 1.1.3.2.1.3, and 1.1.3.2.2.3 and work would be allocated according to Business Process Allocation. Whether any particular leaf node in IT Support Services 1.1.1.1.3, 1.1.1.2.3, 1.1.2.1.3, 1.1.2.2.3, 1.1.3.1.1.3, 1.1.3.1.2.3, 1.1.3.2.1.3, and 1.1.3.2.2.3 has work allocated to it is a function of Business Process Allocation; i.e., some leaf nodes may be inactive at any point in time. Activity between leafnodes in IT Support Services 1.1.1.1.3, 1.1.1.2.3, 1.1.2.1.3, 1.1.2.2.3, 1.1.3.1.1.3, 1.1.3.1.2.3, 1.1.3.2.1.3, and 1.1.3.2.2.3 is facilitated by the Efficacy component 1.4 and connected to the remaining sub-components by the Tech component 1.5.

The leaf node Legal Management Services 1.1.1.1.4, 1.1.1.2.4, 1.1.2.1.4, 1.1.2.2.4, 1.1.3.1.1.4, 1.1.3.1.2.4, 1.1.3.2.1.4, and 1.1.3.2.2.4 represents those business processes relevant to providing legal management services to Mass Action Litigation and the National Legal System. These processes include a variety of undeclared child nodes, which would include vendor relations, client support services, sales, and compliance. These functions would be replicated under all Legal Management Services nodes 1.1.1.1.4, 1.1.1.2.4, 1.1.2.1.4, 1.1.2.2.4, 1.1.3.1.1.4, 1.1.3.1.2.4, 1.1.3.2.1.4, and 1.1.3.2.2.4 and work would be allocated according to Business Process Allocation. Whether any particular leaf node in Legal Management Services 1.1.1.1.4, 1.1.1.2.4, 1.1.2.1.4, 1.1.2.2.4, 1.1.3.1.1.4, 1.1.3.1.2.4, 1.1.3.2.1.4, and 1.1.3.2.2.4 has work allocated to it is a function of Business Process Allocation; i.e., some leaf nodes may be inactive at any point in time. Activity between leaf nodes in Legal Management Services 1.1.1.1.4, 1.1.1.2.4, 1.1.2.1.4, 1.1.2.2.4, 1.1.3.1.1.4, 1.1.3.1.2.4, 1.1.3.2.1.4, and 1.1.3.2.2.4 is facilitated by the Efficacy component 1.4 and connected to the remaining sub-components by the Tech component 1.5.

Offshore Sub-Component 1.1.2.

The Offshore sub-component 1.1.2 constitutes a business unit that is located outside the country of the domicile of the entity operating the invention. The principle purpose of the Offshore sub-component 1.1.2 is to leverage low cost labor pools with qualified skill sets through Business Process Allocation. Of course, it is assumed that such low cost labor pools are obtainable offshore. If, on the other hand, low cost labor pools are available within the country of the entity operating the teachings of the present invention, then the functionality of the Offshore sub-component 1.1.2 which is represented will be completely subsumed within the Domestic 1.1.1 and/or Remote Workers 1.1.3 sub-component, as the case may be.

The Offshore sub-component 1.1.2 has two branches: Internal 1.1.2.1 and External 1.1.2.2. The Internal 1.1.2.1 and External 1.1.2.2 branches of the Offshore sub-component 1.1.2 constitute a further application of Business Process Allocation in order to leverage low cost labor pools with qualified skill sets. The Internal branch 1.1.2.1 represents offshore business processes allocated to the Back Office component 1.1.1 that are completed internally by employees of the entity operating the invention. The External branch 1.1.2.2 represents offshore business processes allocated to the Back Office component 1.1.1 that are completed externally by independent contractors to the entity operating the invention.

The Internal 1.1.2.1 and External 1.1.2.2 branches of the Offshore sub-component 1.1.2 each contain four leaf nodes that provide the business process support designated. The leaf nodes are discussed above.

Remote Workers Sub-Component 1.1.3.

The Remote Workers sub-component 1.1.3 constitutes individual workers that are either Domestic 1.1.3.1 or Offshore 1.1.3.2. The Remote Workers sub-component 1.1.3 and its Domestic 1.1.3.1 and Offshore 1.1.3.2 divisions encapsulate workers that can be either Internal 1.1.3.1.1, 1.1.3.2.1 or External 1.1.3.1.2, 1.1.3.2.2. These workers may operate outside of an office of the entity operating the National Legal System; e.g., a home office. The encapsulated Domestic 1.1.1.3.1 and Offshore 1.1.1.3.2 branches of the Remote Workers sub-component 1.1.2 replicate the functions provided by the independent Domestic 1.1.1 and Offshore 1.1.2 sub-components of the Back Office component 1.1. The Remote Workers sub-component 1.1.3 of the Back Office component 1.1 and its children constitute a further application of Business Process Allocation to leverage low cost labor pools with qualified skill sets.

The Domestic 1.1.3.1 and Offshore 1.1.3.2 branches of the Remote Workers sub-component 1.1.3 ultimately contain the same four leaf nodes as the other direct branches of the Back Office component 1.1, which, as indicated, provide the business process support designated, as discussed above.

Attorneys Component 1.2

FIG. 1 depicts the Attorneys component 1.2, which in turn has three sub-components. In the context of the invention, the Attorneys component 1.2 is the critical component that enables those processes arising from Mass Action Litigation requiring legal decision making and legal input. As work is allocated to the Attorneys component 1.2, a further Business Process Allocation occurs (as occurs when work is allocated to the Back Office component 1.1), allocating the work among the three sub-components of the Attorneys component 1.2: (i) the In-House sub-component 1.2.1; (ii) the Of-Counsel sub-component 1.2.2; and (iii) the Appearance Counsel sub-component 1.2.3.

The principle purpose of the multiple branches of the Attorneys component 1.2 is to leverage low cost labor pools with qualified skill sets through Business Process Allocation. In one embodiment, there are no offshore attorneys represented. In the case that an entity were to pursue Mass Action Litigation in more than one sovereign, it is presumed that each such sovereign would in turn require a separate and distinct instance of the invention to be operated. Of course, the present invention may be readily adapted to allow for attorneys to operate both domestically and offshore. Work performed through the Attorneys component 1.2 is facilitated through Business Process Allocation.

In-House Sub-Component 1.2.1.

The In-House sub-component 1.2.1 contemplates domestic attorneys who, in one embodiment, are employees of the entity operating the invention. The In-House sub-component 1.2.1 completes business processes requiring legal decision making and legal input that are allocated through Business Process Allocation. The division is similar to the Internal branches 1.1.1.1, 1.1.2.1, 1.1.3.1.1, and 1.1.3.2.1 presented in the Back Office component 1.1. These employees are recruited by the entity operating the National Legal System in those jurisdictions where Business Process Allocation indicates it is more efficient and cost effective to employ attorneys on a fixed cost basis.

Of-Counsel Sub-Component 1.2.2.

The Of-Counsel subcomponent 1.2.2 contemplates domestic attorneys who are independent contractors of the entity operating the invention. The Of-Counsel sub-component 1.2.2 completes business processes requiring legal decision making and legal input that are allocated through Business Process Allocation. The division is similar to the External branches 1.1.1.2, 1.1.2.2, 1.1.3.1.2, and 1.1.3.2.2 presented in the Back Office component 1.1. Likewise, these attorneys are recruited by the entity operating the invention in those jurisdictions where Business Process Allocation indicates it is more efficient and cost effective than hiring an In-House attorney 1.2.1 on a fixed cost basis. The attorneys in this group, while operating under the name of the entity operating the National Legal System, typically are paid on a contingency or fee basis as opposed to the fixed cost, salary basis of the In-House attorneys 1.2.1.

In general, Mass Action Litigation is pursued through either an In-House 1.2.1 or Of-Counsel Attorney 1.2.2, depending on the appropriate Business Process Allocation, with the support of the Back Office component 1.1. The standardized processes and procedures represented by the Efficacy component 1.4, through the automated data systems represented by the Tech component 1.5, achieve the desired allocation of work.

Appearance Counsel Sub-Component 1.2.3.

In addition to the In-House 1.2.1 and Of-Counsel 1.2.2 sub-components, another sub-component titled Appearance Counsel 1.2.3 is presented. The Appearance Counsel sub-component 1.2.3 represents an additional set of unique independent contractors utilized as temporary personnel to complete work arising in the Mass Action Litigation process that cannot, or should not (due to cost, liability, or other factors) otherwise be completed through the In-House 1.2.1 or Of-Counsel 1.2.2 sub-components. The role of the Appearance Counsel sub-component 1.2.3 is principally to allocate work related to making limited appearances in primarily administrative or procedural proceedings before the governing authority with jurisdiction in a particular instance of Mass Action Litigation.

These attorneys can be recruited or secured through commercially available means; e.g., http://www.appearingattorney.com, a web site dedicated to providing this type of attorney. These attorneys typically are paid on a fee basis for each appearance the attorney makes.

In-House, Of-Counsel, Appearance Counsel Leaf Nodes 1.2.X.X

All three branches of the Attorneys component share a common set of leaf nodes, designated as: (i) Who 1.2.1.1, 1.2.2.1, and 1.2.3.1; (ii) What 1.2.1.2, 1.2.2.2, and 1.2.3.2; (iii) Where 1.2.1.3, 1.2.2.3, and 1.2.3.3; (iv) When 1.2.1.4, 1.2.2.4, and 1.2.3.4; and (v) How 1.2.1.5, 1.2.2.5, and 1.2.3.5. Together, these leaf nodes are similar in construct to the ultimate leaf nodes of the Back Office component 1.1.

“Who” 1.2.1.1, 1.2.2.1, and 1.2.3.1 describes the particular attorney in the identified branch who will process the work designated through Business Process Allocation; e.g., an In-House attorney 1.2.1 in contrast to an Of-Counsel attorney 1.2.2, and the particular In-House attorney 1.2.1. “What” 1.2.1.2, 1.2.2.2, and 1.2.3.2 describes the work the particular attorney in the identified branch is to complete; e.g., reviewing a complaint drafted for a particular instance of Mass Action Litigation. “Where” 1.2.1.3, 1.2.2.3, and 1.2.3.3 describes where the work will take place (attorneys must often perform work outside of any given fixed location); e.g., at a particular court house in a particular jurisdiction. “When” 1.2.1.4, 1.2.2.4, and 1.2.3.4 describes by when the work must be completed or performed. “How” 1.2.1.5, 1.2.2.5, and 1.2.3.5 is the business process to be followed in performing the work; e.g., the specific steps the attorney is to take in reviewing a complaint drafted for a particular instance of Mass Action Litigation. The flexible allocation of the leaf nodes permits the correct resource to be selected, as work allocated to Attorneys may in some cases require expert knowledge related to a particular jurisdiction. While expert knowledge may be required, it is subsumed to the standardized process presented by the Efficacy component 1.4 and enabled through the Tech component 1.5.

Litigation Component 1.3.

While efficient prosecution of Mass Action Litigation is the purpose and the result of the National Legal System, litigation is itself a component of the system. The Litigation component 1.3 serves to define and filter the types of litigation that will function efficiently through the National Legal System. The Litigation component 1.3 is primarily a generic filtering mechanism with attributes specific to the National Legal System and the type of litigation being pursued. Each and every claim passes through the filter prior to being processed in the system.

The Litigation component 1.3 also serves to capture those actions taken in the litigation process as a result of interacting with external parties who either facilitate litigation; e.g., courts, or the opposing party in an instance of litigation. This function of the Litigation component 1.3 is shown in FIG. 3, where certain work generated relative to a particular instance of litigation, and directed to an external party, flows through the Back Office 1.1 and Attorneys components 1.2 to the Litigation component 1.3.

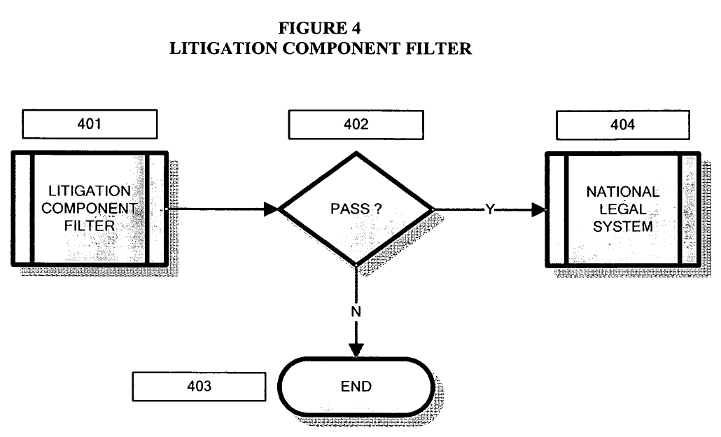

The practical application of the Litigation component 1.3 as a filtering mechanism is shown in FIG. 4. When a particular claim passes through the elements of the Litigation component filter 401, 402, it is in a class of claims deemed “Mass Action Litigation” and the claim is loaded for processing 404. This particular class of claims drives the National Legal System, and is a predicate to its operation. There are many distinct types of Mass Action Litigation; e.g., consumer debt collection and mass copyright infringement.

The Litigation Component Filter contemplates a Boolean test 402 to determine whether the sub-elements shown below Mass Action Litigation 1.3.1 and discussed below test true. The Litigation Component Filter 401 may be implemented through any of a number of programmatic techniques. In one embodiment, the filter 401 may be implemented by creating a variable for each of the sub-elements shown under Mass Action Litigation 1.3.1 and storing a binary value in that variable relative to the particular sub-element. Thus, the filter becomes a simple case of Boolean logic whereby, when all the variables that comprise the Litigation Component Filter 401 are equal to 1, then the condition is true, and the particular instance of litigation passes through the filter 402. When the condition is not true, the particular instance of litigation fails and does not pass through the filter 403.

Whether a particular set of claims qualifies as Mass Action Litigation and passes through the filter 402 is determined by examining the predicate conditions of that qualification, as indicated. In general, the definitional elements are: (i) High Volume of Relatively Low Value claims 1.3.1.1; (ii) a Narrow Legal Area 1.3.1.2; (iii) Similarly Situated Plaintiffs 1.3.1.3; (iv) Similarly Situated Defendants 1.3.1.4; (v) Mass Document Customization Achievable 1.3.1.5; and (vi) Standardized Policies 1.3.1.6. In any embodiment, these six conditions must be met in order for a set of claims to be defined as a Mass Action Litigation 1.3.1 (and pass through the Litigation Component Filter 402). Examples of claims that typically qualify as Mass Action Litigation claims are: (i) claims for consumer debt collection; and (ii) claims for copyright infringement arising out of peer-to-peer file trading networks, etc.

High Volume of Relatively Low Value claims Element 1.3.1.1

Mass Action Litigation 1.3.1 is dependent on a high volume of relatively low value claims 1.3.1.1. The typical claim volume necessary to efficiently operate the National Legal System is several thousand per month. Without a critical volume of claims, a low cost operating environment, which in turns permits the processing of low value claims, cannot readily be achieved. Low value claims, meaning those claims generally with a value of less than US$15,000 (as a non-limiting example), are also a pre-requisite. Claims with an amount in controversy in excess of this amount are usually readily serviced by the existing market, thus the National Legal System does not fill a need in this area. However, the National Legal System could, of course, be used in these situations as well. This condition will be tested in the Litigation Component Filter 402. To the extent a particular set of claims is within the permitted range defined for a particular type of Mass Action Litigation, the value relative to this particular element will be true and the claims will be loaded for processing 404 presuming the other required elements are satisfied.

Narrow Legal Area Element 1.3.1.2

Mass Action Litigation is dependent on a Narrow Legal Area 1.3.1.2. A Narrow Legal Area 1.3.1.2 permits the derivation of standardized processes and policies that can be effectively extracted into the business rules required for the processing of claims through the National Legal System. Narrow Legal Area 1.3.1.2 is defined as a category of law that: (i) has a limited body of related and common substantive and procedural law 1.3.1.2.1; and (ii) has claims that typically share a common set of material facts 1.3.1.2.2. This condition will be tested in the Litigation Component Filter 402. To the extent a particular set of claims is within the permitted range defined for a particular type of Mass Action Litigation, the value relative to this particular element will be true and the claims will be loaded for processing 404 presuming the other required elements are satisfied.

Limited Body of Related and Common Substantive and Procedural Law Sub-Element 1.3.1.2.1

A limited body of related and common substantive and procedural law 1.3.1.2.1 (“substantive” meaning the body of law governing how the facts relevant to a particular claim will be treated and “procedural” meaning the law governing the process that will be followed when applying the substantive law) means that the statutory and case law applicable to the resolution of claims of the type is similar with universal unifying elements in different jurisdictions. This is the body of law that dictates how the plaintiff that is pursuing a particular claim will have to plead its case in a document filed with the court, what documents the plaintiff will need to support its case, and how the court will judge the facts of the plaintiff's case.

For example, in the legal area relative to the collection of claims for debt obligations arising out of consumer credit card agreements, the case law and statutory law are similar in every state of the United States. Not only are the case law and statutory law similar, there are unifying elements of Federal law that are applicable in all states, for example, the Fair Debt Collection Practices Act (“FDCPA”), 15 USC § 1692, et seq.

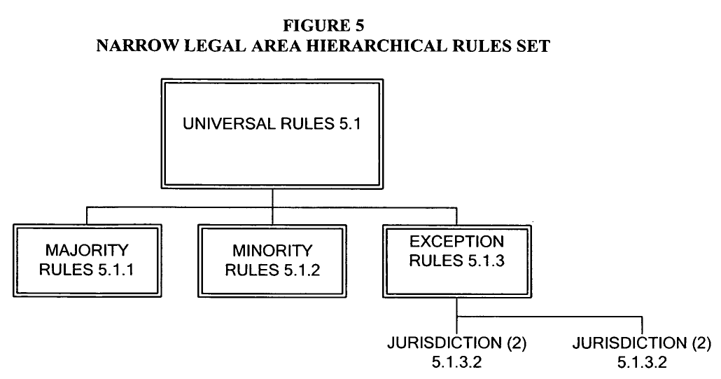

The processing of claims arising out of consumer credit card debt constitutes a Narrow Legal Area 1.3.1.2, in that a set of hierarchical rules may be developed applicable to such cases as shown in FIG. 5. The root node of the hierarchy is the rule set that is universal to all jurisdictions 5.1. The children of the root node 5.1 are nodes for the majority rule set 5.1.1, the minority rule set 5.1.2, and the exception rule set 5.1.3. Of the children, only the exception node 5.1.3 in turn has children, which are included on an as needed basis for each jurisdiction 5.1.3.x. The construct of the majority rule set 5.1.1 and minority rule set 5.1.2 permits rules that are not universal 5.1 and not exception 5.1.3 based to be normalized (with the relevant jurisdictions classified as a member of each such rule set group accordingly). The construct is not exclusive, as it is possible that more than two such groupings could be utilized to classify rules; e.g., in the case that one majority rule and two minority rules exist. (See infra, “Standardized Processes sub-component 1.4.1,” for further discussion of the practical application of these hierarchical rules).

The “narrowness” of any given legal area can be confirmed by calculating the ratio of the sum of universal, majority and minority rules (the “normalized rule set”) to the sum of the exception rules. As the ratio of the normalized rule set 5.1, 5.1.1, 5.1.2 to the exception rules set 5.1.3 increases, the particular legal area approaches the idealized definition of Narrow Legal Area 1.3.1.2, which is a legal area that is applicable to many jurisdictions, but comprised entirely of universal rules 5.1.

The application of these hierarchical rule principles is readily observed in the context of a specific example. The proof and evidence required to prove any particular legal claim is a matter governed by substantive law. The body of substantive law applicable to a particular legal area and the variety of proof and evidence required to prove a claim through the lens of that substantive law is proportional. As the type of proof or evidence required significantly varies from jurisdiction to jurisdiction, so does the body of applicable substantive law increase. From the existence of one element, the other can be inferred. In the area of consumer credit card debt, the limited variety of proof and evidence required is evidenced by the majority rule 5.1.1, which merely requires that the plaintiff provide a sworn affidavit attesting to the amount due and owing to the plaintiff to support the bringing of a particular claim.

The normalization of the proof required for a claim of this type is further demonstrated through a particular example of a universal rule 5.1 applicable to all cases of the type when a greater quantum of proof is required (typically occurring when a defendant contests a plaintiff's averment of fact by affidavit). The exemplary universal rule strongly inhibits a defendant's ability to contest the proof provided by the plaintiff by defining a single standard of proof. The universal rule is embodied within the Truth-in-Lending Act, 15 USC 1601 et seq., which establishes that if the plaintiff provided periodic statements of account to the defendant, and the defendant did not object to those statements within a prescribed period of time, mere presentment of copies of the relevant statements is sufficient to overcome the objections of the defendant.

Whether this particular sub-element is true relative to any particular claim will be tested by the Litigation Component Filter 402. When the condition is satisfied, the variable in the Litigation Component Filter relative to this particular sub-element will be defined as true, and the claim will be loaded for processing 404 presuming the other required elements are satisfied.

Common Set of Material Facts Sub-Element 1.3.1.2.2

A Common Set of Material Facts 1.3.1.2.2 (which is used in the context of a typical pattern of facts, not a shared set of facts common to multiple claims) is often the analogue of Narrow Legal Area 1.3.1.2. It is unusual to have a Narrow Legal Area 1.3.1.2 where claims within that area do not share a Common Set of Material Facts 1.3.1.2.2. The converse holds true as well. A Common Set of Material Facts 1.3.1.2.2 is a required element within the context of Mass Action Litigation 1.3.1.

The relationship between Common Set of Material Facts 1.3.1.2.2 and Narrow Legal Area 1.3.1.2 is symbiotic, in that the limited universe of facts generally begets the limited body of substantive and procedural law relevant to those facts. The typical fact pattern has become so well defined over time that the vast majority of claims never present novel or challenging issues when viewed through the lens of the applicable substantive and procedural law. For example, in the area of consumer credit card debt claims, the typical fact pattern would be: (i) the defendant entered an agreement with the plaintiff credit card company whereby the defendant was provided with a revolving line of credit; (ii) the defendant obtained goods and services for his or her benefit by using the line of credit; and (iii) that the defendant failed to pay the amount then due and owing to the plaintiff credit card company arising out of the defendant's use of the line of credit pursuant to the terms and conditions of the agreement with the plaintiff. A Narrow Legal Area 1.3.1.2 is a combination of a small body of law 1.3.1.2.1 and a typical set of facts 1.3.1.2.2. Whether any particular claim is within a Narrow Legal Area 1.3.1.2 can be observed by examining a statistically valid sample of claims and: (i) observing a high ratio of universal 5.1, majority 5.1.1, and minority rules 5.1.2 to exception rules 5.1.3; and (ii) a high ratio of claims to sets of typical fact patterns 1.3.1.2.2.

Whether this particular sub-element is true relative to any particular claim will be tested by the Litigation Component Filter 402. When the condition is satisfied, the variable in the Litigation Component Filter relative to this particular sub element will be defined as true, and the claim will be loaded for processing 404 presuming the other required elements are satisfied.

Similarly Situated Plaintiffs Element 1.3.1.3

Mass Action Litigation 1.3.1 also depends on similarly situated plaintiffs 1.3.1.3. Without similarly situated plaintiffs 1.3.1.3, it is unlikely that claims would share a common set of material facts 1.3.1.2.2. To engender economies of scale relative to plaintiffs participating in the National Legal System and enable not only sophisticated plaintiffs, but unsophisticated plaintiffs as well, to realize the benefits of the National Legal System, several foundational elements are required to support the relationship between the operator of the National Legal System and its plaintiff participants. These elements include: (i) efficient data transfer 1.3.1.3.1; (ii) efficient transaction processing 1.3.1.3.2; (iii) efficient reporting 1.3.1.3.3; (iv) efficient contracting for the provisioning of the National Legal System as a service 1.3.1.3.4; (v) efficient media management 1.3.1.3.5; and (vi) efficient settlement negotiations 1.3.1.3.6. By addressing these elements in a standardized and systematic manner, the utility of the National Legal System is extended to unsophisticated plaintiffs, as they can meet the requirements of these foundational elements without investing the time and resources which would otherwise be required. Each sub-element of the Similarly Situated Plaintiffs element 1.3.1.3 is readily satisfied through existing, commercially available technology, as discussed below in the section relevant to each such sub-element.

Whether this particular element is true relative to any particular claim will be tested by the Litigation Component Filter 402. When the condition is satisfied, the variable in the Litigation Component Filter relative to this particular element will be defined as true, and the claim will be loaded for processing 404 presuming the other required elements are satisfied. Whether this condition is satisfied is dependent on whether the particular plaintiff submitting the particular claim satisfies the relevant sub-elements 1.3.1.3.1, 1.3.1.3.2, 1.3.1.3.3, 1.3.1.3.4, 1.3.1.3.5, and 1.3.1.3.6, which are discussed below.

Efficient Data Transfer Sub-Element 1.3.1.3.1.

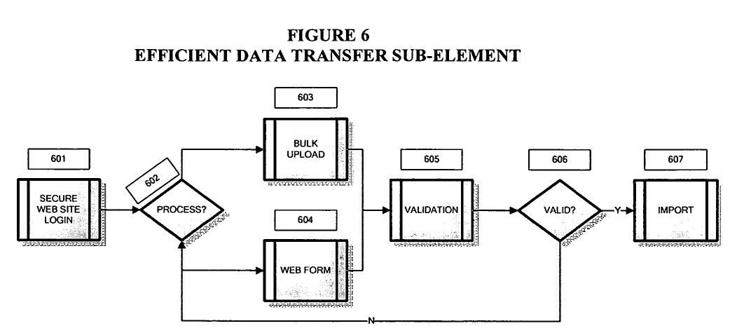

Efficient Data Transfer 1.3.1.3.1 is a foundational sub-element required for utilization of the National Legal System. The data transfer process is shown collectively in FIG. 6. In order to process a high volume of claims, the operator of the National Legal System receives the common set of facts relative to any particular defendant in a consolidated, normalized data set—which may be quite complex 607. This requirement is readily solved through the use of the Internet and commercially available web server software. Examples of commercially available web server software include Microsoft Internet Information Server and Apache. Each of these products requires an operating system to function. In the case of Microsoft Internet Information Server, the operating system required is Windows NT, Windows 2000 Server or Windows 2003 Server. In the case of Apache, almost any commonly available UNIX or Linux platform will function as the appropriate operating system.

To resolve the issue of efficient data transfer 1.3.1.3.1, the operator of the National Legal System can establish a web based portal to serve plaintiffs. The portal may be based on Hypertext Markup Language (HTML) or Extensible Markup Language (XML), and may incorporate a variety of other functional technologies, including, without limitation, Active X, Java, VB Script, Perl, Python, etc. Through this portal, each plaintiff is able to log on 601 to a secured web site that follows industry standard security practices and procedures, encrypting each connection with the Secure Sockets Layer (SSL) protocol. Once logged in to the secure web site, each plaintiff then is able to do one of two things to fulfill the requirement of efficient data transfer 602.

First, a particular plaintiff may upload the requisite data set in a standard format defined or supported by the operator of the National Legal System 603. Existing standards exist within the public domain; e.g., the “You've Got claims” standard (http://www.youvegotclaims.com/). Plaintiffs with particularly high volumes of claims will likely use this option 603. This option is supported using commercially available technology such as a File Transfer Protocol server. In the case of a web portal built on a variant of a Microsoft operating system and running Internet Information Server, the Microsoft FTP Server software is included with Internet Information Server. In the alternative, any of a number of commercially available alternatives for the Microsoft platform can be utilized; e.g., Serv-U FTP Server, War FTP Daemon, etc. In the case of a web portal built on a variant of Linux or UNIX, each such variant ordinarily includes with the operating system an FTP server that may be used to fulfill this function.

Second, the particular plaintiff may access a web based form template containing fields for all necessary facts to support a particular claim 604. These templates clearly define data types for each field in the form, designate which fields are required, and perform validations 605, 606 on data prior to posting the data from the form to a database established by the operator of the National Legal System to store the information relative to submitted claims 607. Likewise, any data uploaded by a particular plaintiff in bulk using the standard defined by the operator of the National Legal System is validated 605, 606, and then imported 607 to the same data store in a normalized format.

Data validations 605, 606 will vary depending on the substance of the data set uploaded (which is dependent on the type of Mass Action Litigation 1.3.1 being pursued). As an example, typical elements may include dates of specific occurrences; e.g., the date the particular claim arose. A date that is entered or included in an uploaded data set may be validated to ensure that the date is in the correct format (e.g., ISO 8601), that the date is valid (e.g., it occurs in the past), and that the date is within the permitted range of dates (e.g., relative to a particular type of claim, there may be a limited time in which litigation may be pursued after the date on which the claim arose (which may vary on a jurisdiction to jurisdiction basis)). Numerous additional validations can be conducted; e.g., when an address is entered as a data element, the postal code associated with the address may be validated as valid or invalid. These data validations 605, 606 may be carried out in one embodiment through front end scripts on the secure web portal (e.g., Perl scripts), or in another embodiment on the back end database via a SQL stored procedure. In this manner, efficient data transfer 1.3.1.3.1 is achieved regardless of the sophistication or size of the particular plaintiff.

Transaction Processing Sub-Element 1.3.1.3.2.

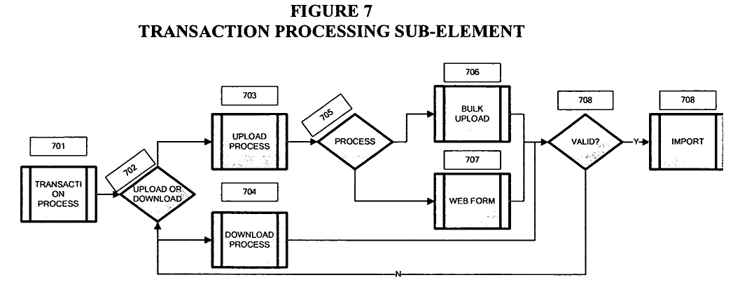

The second foundational requirement is transaction processing 1.3.1.3.2. The transaction processing process is shown in FIG. 7. Mass Action Litigation typically generates thousands of payments from defendants each month (both to the operator of the National Legal System and directly to plaintiffs). As a result, thousands of requests for payment from the entity operating the National Legal System are also generated. In addition, other relevant transactions, e.g., interest transactions, may need to be transferred between the operator of the National Legal System and particular plaintiffs. To efficiently and effectively process the volume of transactions generated through Mass Action Litigation 1.3.1, a well defined process and procedure must be in place. This issue is again addressed through readily available commercial means, as discussed below.

The operator of the National Legal System defines in the contract for services it enters into with each plaintiff the format of a data file to be used to transmit transactional data. A commercially available standard in the public domain such as the “You've Got claims” standard may be used. At a pre-determined interval, the operator of the National Legal System generates this file for each plaintiff and uploads the file to a secure file storage area accessible through the secure web site operated as part of the National Legal System. Each plaintiff can then log on to the web site and choose to download 702, 704 the data file containing the transactional data, utilizing the same FTP technology discussed above. Likewise, each plaintiff will, at a pre-determined internal, format and upload 703, 705, and 706, or use a web based template to enter 703, 705, and 707, transactional information relevant to transactions processed directly by the plaintiff, again using the same technology discussed above relative to bulk data uploads or entry of information through a web based form template.

To facilitate access to transactional data (and receive transactional data) for plaintiffs who lack the sophistication to format and upload or download transaction files in a standardized data format 703, 705, and 707, the web based interface provides a method whereby a particular plaintiff can view transactional data relative to a particular claim through the user interface, as indicated. Likewise, a web based form for uploading transactional data relative to particular claims is provided 707.

In all instances, validations are performed on data uploaded or downloaded through the Transaction Processing sub-element 708 before the data is imported 709. These validations 708 are similar to those carried out in the Efficient Data Transfer sub-element shown in FIG. 6. For example, the dates of individual transactions may be checked to determine if a particular transaction falls within a certain permitted range, e.g., after the date the claim arose.

The web site serves as a clearing house for transactions between the operator of the National Legal System and each plaintiff. The system is a trust but verify system. While the operator of the National Legal System has no direct way to determine whether each plaintiff has posted all transactions processed directly by that plaintiff and vice versa, each party is the beneficiary of audit rights in the contract for services entered between the parties.

Reporting Sub-Element 1.3.1.3.3.

The third foundational sub-element is reporting 1.3.1.3.3. The reporting options range from simple to sophisticated and customized. While sophisticated and customized reporting is required, this requirement is addressed through a web interface.

The operator of the National Legal System develops a series of standard reports based on its experience with particular plaintiffs. This set of standard reports is then made available to all plaintiffs upon log on to the secured web site. This type of report would generally be generated and made available through commercially available reporting tools that process the standardized report templates on a scheduled basis. As an example, each particular standard report might be developed to process against the underlying database storing the data using a SQL stored procedure scheduled to run using a SQL job scheduler (note that the database variant will likely differ depending on the operating system utilized by the operator of the National Legal System). For example, to the extent the operator of the National Legal System uses a Microsoft operating system such as Windows 2000 Server, the likely variant of the database would be Microsoft SQL Server 2000. Likewise, on a Linux or UNIX platform, the MySQL database or another SQL database such as Oracle might be used. The output format of the particular report might be in any of a variety of formats, including HTML or XML, which could be viewed directly through the web based interface.

In addition, to support the level of sophistication demanded by sophisticated plaintiffs, the secure web site may host a commercially available web based interface to an OLAP (Online Analytical Processing) data store and provide instructions on the use of the OLAP data store. An example of commercially available tools of this type includes Microsoft Analysis Services (included with Microsoft SQL Server) and Cognos (available on Microsoft, Linux and UNIX platforms). By utilizing the OLAP data store, any plaintiff is able to produce customized reports formatted along the dimensions selected by the particular plaintiff.

Finally, the operator of the National Legal System defines a standard master file layout, containing all the relevant fields originally transmitted to the operator of the National Legal System by a particular plaintiff and the updated values of those fields, along with all other relevant fields captured by the operator of the National Legal System. The operator of the National Legal System then periodically posts this standard master file to the secured web site for download by particular plaintiffs using the FTP technologies previously discussed. By providing three reporting mechanisms, the operator of the National Legal System sufficiently meets the needs of any plaintiff.

Contracting Sub-Element 1.3.1.3.4.

The fourth foundational sub-element is contracting 1.3.1.3.4. Individual plaintiffs may desire to have a contract tailored to their specific needs. This flexibility is provided on a large scale by providing a standard based contract with a number of permitted options to suit market demand based on the experience of the operator of the National Legal System. As a result, the boundaries of permitted negotiation are fixed for the operator of the National Legal System and a contract is quickly assembled from the base contract and a permitted set of optional or required components. While this contractual flexibility supports the demands of sophisticated plaintiffs, a non-negotiable standard base agreement is also made available through the web interface. A new plaintiff can thereby access the web interface, complete the click-through standard based agreement, and provide other identifying information, and immediately begin uploading claims through the web interface. The technology utilized for providing this type of click-through agreement is the same commercially available technology utilized to host the web interface and provide functionality to users of the web interface through web based forms.

Media Management Sub-Element 1.3.1.3.5.

The fifth foundational sub-element is media management 1.3.1.3.5. A Narrow Legal Area 1.3.1.2 has certain requirements of proof that must be met. To meet these requirements of proof, certain documents may be required of a particular plaintiff. To manage this issue, the same web based interface is utilized with each plaintiff. The operator of the National Legal System, when and if a particular document is required, makes a request for the particular document through the web based interface, clearly identifying the claim to which the document is relative, the particular document required, when the document must be received by, and whether an original document is required.

The particular plaintiff then acknowledges this request after logging onto the web based interface, indicating the date by which the document will be provided. To the extent a copy of the document is required, the particular plaintiff can then either: (i) log back onto the web site, access the particular document request, and upload a scanned image of the requested document; or (ii) log back onto the web site, access the particular document request, print a copy of the particular document request (which is printed with a bar code identifier unique to the relative claim and document), and fax the printed copy of the document request and document to a designated fax number provided by the plaintiff. To the extent a particular document is faxed, it is received by a commercially available fax server such as Right Fax of Fax Senior capable of recognizing the bar code printed on the cover sheet and associating the particular fax with the correct claim and document. By utilizing the mechanism provided by the web interface and the same commercially available technology otherwise utilized to support that interface, required media is readily managed and tracked.

Settlement Negotiations Sub-Element 1.3.1.3.6.

The final foundational sub-element is relative to settlement negotiations 1.3.1.3.6. While the contract between the operator of the National Legal System and a particular plaintiff will establish a base settlement authority that is discretionary to the operator of the National Legal System, many exceptions arise. These exceptions must be readily and quickly analyzed by plaintiffs. To enable any plaintiff to expediently judge exception requests, all exception requests are presented through the secure web based interface in a standardized template identifying a standard set of facts relevant to discount requests. In this way, the operator of the National Legal System simply posts exception requests in the standard format, and each plaintiff judges the exception requests based on a common set of information. The technology required to support this functionality is provided through the same commercially available technology otherwise utilized to support the web interface.

Similarly Situated Defendants Element 1.3.1.4

A large number of similarly situated defendants 1.3.1.4 is also a required element of Mass Action Litigation. The defendants are similarly situated in that there are a very large number of potential defendants in a Narrow Legal Area 1.3.1.2 sharing a similar set of common facts at any given time. Typically, the overall ratio of plaintiffs to defendants will be very small (1 to thousands). The fact that the defendants are concentrated in a Narrow Legal Area 1.3.1.2 creates efficacy in the relationship between the plaintiff and the defendants; i.e., all the defendants can be treated in a similar manner. A good example of a set of defendants who fall within the scope contemplated by Mass Action Litigation 1.3.1 would be individuals who engage in copyright infringement by illegally downloading electronic music files over the Internet through peer-to-peer file sharing networks.

Mass Document Customization Achievable Element 1.3.1.5.

Litigation is a document driven process (whether those documents are paper or electronic based). As a result, the set of documents required to support a particular Narrow Legal Area 1.3.1.2 must be finite and readily customizable using mass document assembly technologies 1.3.1.5 (e.g., Microsoft Word merge from a SQL database such as Microsoft SQL Server or MYSQL). If the set of documents required cannot be mass produced using the claim specific variables provided by a particular plaintiff, the claim cannot be subject to the Mass Action Litigation 1.3.1 process. This requirement is almost always fulfilled to the extent a Narrow Legal Area 1.3.1.2 is present. Exceptions may arise where there are particular documents that require the signature of a large number of parties or for other reasons. In these instances, the particular claim does not fit within the context of Mass Action Litigation 1.3.1, as it is likely significant manual processing will be required to produce the required documents. To the extent significant manual processing of documents is required, the claim cannot be processed in the National Legal System.

Standardized Policies Element 1.3.1.6.

Finally, for a claim to fit within the context of Mass Action Litigation, it must be subject to standardized policies 1.3.1.6, just as it is subject to standardized processes defined by rules (see supra, “Narrow Legal Area 1.3.1.2”; see infra, “Efficacy 1.4”). Without standardized policies 1.3.1.6, claims cannot be efficiently processed. In general standardized policies exist 1.3.1.6 relative to: (i) Risk Management; (ii) Legal Compliance; (iii) Contract Compliance; (iv) Issue Specific Responses; (v) Quality Assurance; (vi) Audit; (vii) Security; and (viii) Reporting. These policies 1.3.1.6 are extracted to a set of business rules that can be applied to all claims at a universal level, at a plaintiff specific level, and at a jurisdiction specific level. The application of the clearly defined policies 1.3.1.6 is defined via the same type of hierarchical structure discussed above and below. (See supra, “Narrow Legal Area 1.3.1.2”; see infra, “Efficacy 1.4.”)

Efficacy Component 1.4.

Efficacy 1.4 is itself described as a component of the National Legal System. Efficacy 1.4, in the context of the National Legal System, turns on two sub-components: Standardized Processes 1.4.1 and Standardized Policies 1.4.2, which together define Business Process Allocation 1.4.3 from the standardized process and policy perspective (which is implemented by the Tech component 1.5). Efficacy 1.4 is in effect the controller of the assembly line comprising the National Legal System, which takes incoming claims and slices them into their component parts in the form of work units to be completed by qualified, assigned personnel within the context of either the Attorneys 1.2 or Back Office 1.1 components and facilitated through the Tech component 1.5.

Standardized Processes Sub-Component 1.4.1.

As detailed above (see supra, “Narrow Legal Area 1.3.1.2”), within the context of Mass Action Litigation 1.3.1—a standardized set of universal 5.1, majority 5.1.1, minority 5.1.2, and exception 5.1.3 rules can be extracted. For example, in the context of consumer credit card debt collection, these rules may take the form of a requirement of the FDCPA. In particular, the requirement may be as follows: Each and every defendant to a claim must receive a letter from the operator of the National Legal System within five days of the date of first contact with such defendant, unless the first contact is initiated through the service of a law suit, which letter must contain certain language required by the FDCPA and state law.

The Standardized Processes 1.4.1 sub-component of the Efficacy component 1.4 takes this rule and specifies how and by whom this requirement is to be fulfilled in a standardized manner. A rule is taken and turned into a series of tasks that must be completed in order to fulfill the rule. Thus, the tasks relative to the fulfillment of this particular rule may be:

| Task # | Description | Responsible | Trigger |
|---|---|---|---|
| 1. | Draft letter templates - | Legal Department | As Needed |
| | universal, majority rule, | | |
| | minority rule and exception | | |
| 2. | Transmit letter templates to | Production IT | As Needed |
| | External Print Shop in required | | |
| | format | | |
| 3. | Obtain quality samples from | Legal Department | As Needed |
| | External Print Shop | | |
| 4. | Approve Print Samples | Legal Department | As Needed |
| 5. | Systematically Verify Data | Systematic Procedure | Automatic on Claim |
| | Elements Required | | Receipt |
| 6. | Transmit Data to Third Party | Systematic Procedure | Automatic after Task 5 |
| | Data Supplementation Agent to | | |
| | Verify and Update Data | | |
| 7. | Received and Verify Data | Systematic Procedure | Automatic after Task 6 |
| | Received from Third Party Data | | |
| | Supplementation Agent | | |
| 8. | Update Data Store with new | Production IT | Manual after |
| | Information | | Task 7 |
| 9. | Generate Purchase Order for | Systematic Procedure | Automatic after Task 8 |
| | Required Letters | | |
| 10. | Transmit Purchase Order to | Systematic Procedure | Automatic after Task 9 |
| | Designated Party | | |
| 11. | Approve Purchase Order | Controller | Manual after Task 10 |
| 12. | Generate File for External Print | Systematic Procedure | Automatic after Task 11 |
| | Shop with required data | | |
| | elements and identifying letter | | |
| | template to use. | | |
| 13. | Generate Review File for | Legal Department | Manual after Task 12 |
| | Attorney Review of Generated | | |
| | Letters | | |
| 14. | Receive Approval for Letters | Legal Department | Manual after Task 13 |
| | from Attorney | | |
| 15. | Transmit File to External Print | Systematic Procedure | Automatic after Task 14 |
| | Shop | | |
| 16. | Receive and Review Randomly | Legal Department | Manual after Task 15 |
| | Seeded Letter Samples Produced | | |
| | by External Letter Shop | | |

In completely defining one area of Mass Action Litigation 1.3.1, hundreds of such rule sequences or workflows are produced. FIG. 2 represents a top level workflow for the consumer credit debt collection area, which has been described as one area that fits the definition of Mass Action Litigation 1.3.1. In addition to the general schematic shown above, each rule in particular will have additional attributes relative to that rule. The required attributes are:
Rule Type—Universal, Majority, Minority, or Exception
Skills Required—(This will be a job classification; e.g., IT Production Type 1, Type 2, Attorney Type 1, Attorney Type 2, etc.)
Geographic Requirements—the jurisdiction where the actor must be to carry out the task (if applicable)
Timing Required—the time typically required to complete the task
Time Allotted—the time in which the task must be completed
Cost Requirements—the maximum cost that can be expended on the task

The Rule Type for each segment of work in a particular workflow is critically important, as all the potential rules for a potential work flow are hierarchically parsed by the jurisdiction related to the particular task being completed to dynamically produce a particularized workflow for a particular claim in a particular jurisdiction. Thus, assuming Rules 5-16, excepting rule 12, are universal rules, and rule 12 implies a majority and a minority rule depending on the jurisdiction related to a particular claim, the above workflow is in effect applied to an individual claim in the same manner, excepting the application of Rule 12, which, since no universal rule is defined, will look to the next level of the hierarchy—majority and minority rules.

The majority and minority rules relative to Rule 12 might dictate:

| | | | | |
|---|---|---|---|---|
| 12. | Generate File for | Systematic | Automatic after | Jurisdiction |
| | External Print | Procedure | Task 11 | AL, AZ, AK |
| | Shop with re- | | | GA, CA, NY |
| | quired data | | | |
| | elements and | | | |
| | identifying letter | | | |
| | template # 1. | | | |
| 12. | Generate File for | Systematic | Automatic after | Jurisdiction |
| | External Print | Procedure | Task 11 | OH, FL, VA, |
| | Shop with re- | | | WY, MO, NV . . . |
| | quired data | | | |
| | elements and | | | |
| | identifying letter | | | |
| | template # 2. | | | |

By parsing the applicable rules by rule type and following the hierarchy when a top level rule is not available, the procedure applicable to a particular claim is produced.

Skills Required is likewise a critical component of each individual step in a workflow. Skills Required is defined by reference to job classification. Thus, for jobs that must be completed by the legal department, a particular task might require Attorney Type 1, Attorney Type 2, or Attorney Type 3. Each type of attorney will have a different skill set.

Geographic Requirements defines whether an actor must be present in a particular jurisdiction to complete a particular task. For example, certain tasks may require court appearances and an attorney in that particular jurisdiction may be required.

Timing Required defines the typical time required to complete the specific task. This variable generally is defined in minutes.

Time Allotted defines the maximum time in which the particular task can be completed.

Cost Requirements defines the maximum cost which can be allocated to the particular task.

When combined, these variables produce a matrix of requirements relative to any particular task (see infra, “Business Process Allocation sub-component 1.4.3”).

Standardized Policies Sub-Component 1.4.2.

As detailed above (see supra, “Standardized Policies Element 1.3.1.6”), within the context of Mass Action Litigation 1.3.1—a set of standardized policies exist relative to: (i) Risk Management; (ii) Legal Compliance; (iii) Contract Compliance; (iv) Issue Specific Responses; (v) Quality Assurance; (vi) Audit; (vii) Security; and (viii) Reporting. The Standardized Policies 1.4.2 sub-component of the Efficacy component 1.4 takes these policies and specifies how and by whom they are implemented across all components of the National Legal System in a standardized manner. Business Process Allocation Sub-Component 1.4.3.

Optimized Business Process Allocation 1.4.3 is the process of assigning particular tasks in a workflow to available workers for completion. To accomplish this, several prerequisites exist. First, each available worker, whether an employee or contract worker, is defined in terms of his or her relevant attributes. Thus, the skills of each such worker are defined by reference to a clearly defined job function; e.g., Attorney Type 1, Attorney Type 2, etc. The geographic location of each worker is defined. The cost of each worker is defined and a quality ranking is assigned to each worker. In addition, the availability of each worker based on scheduled tasks is tracked in an electronic calendaring system. Thus, each time a particular worker is scheduled to complete a particular task, time is allotted in that worker's calendar to complete the task. Likewise, when an assigned task is complete, the calendar reflects that the task has been completed. (Note, it is possible to have additional variables relative to both work units and the available workers; e.g., the speed of a particular worker, which would be similar to the quality rating).

After completing the matrix relative to available workers, the following structure becomes evident:

| | | | | Cost Per | Time |
|---|---|---|---|---|---|
| Worker | Type | Location | Quality | Hour | Available |
| 1 | Attorney 1 | Georgia | 2 | 50 | 60 Minutes |
| 2 | Attorney 1 | Georgia | 3 | 50 | 120 Minutes |
| 3 | Attorney 1 | Florida | 3 | 50 | 30 Minutes |
| 4 | Attorney 2 | Nevada | 2 | 75 | 50 Minutes |
| 5 | Attorney 2 | Nevada | 4 | 75 | 30 Minutes |
| 6 | Attorney 2 | Nevada | 3 | 75 | 90 Minutes |
| 7 | Attorney 2 | California | 2 | 75 | 100 Minutes |
| 8 | Attorney 2 | California | 4 | 75 | 120 Minutes |

Having completed the matrix relative to available workers and the matrix relevant to each step in a particular workflow, it is systematically determined who is available to complete the work and who is the best worker to complete the work based on the quality ranking. (Note that a more sophisticated weighted ranking could certainly be substituted whereby additional variables are considered in the ranking; e.g., cost and/or speed if present.)

The process has two parts. The first part is a filtering process. A particular work unit requires a particular skill set, requires a particular amount of free time, has a maximum cost, and may have a geographic requirement. Thus, given the example set detailed above, if a particular unit of work required a skill set of Attorney 1, all available workers with the skill set Attorney 2 are immediately eliminated, presuming the “Attorney 2” classification does not subsume the skill set of the “Attorney 1” classification. Presuming the particular work unit does not have a geographic requirement, but is anticipated to take 60 minutes, worker number 3 is eliminated. All things otherwise being equal between the remaining workers (worker number 1 and worker number 2), worker number 2 is then selected to complete the work based on his/her quality ranking.

By clearly defining each and every step relative to particular rules of a Mass Action Litigation type and transforming those legal rules into detailed business rules, each work unit can be defined in terms of the requirements to complete that unit of work. By likewise defining the pool of available workers by the selected attributes, the pool of available workers are easily filtered against the work load to select the appropriate personnel to complete the task through a quality ranking (or a more sophisticated ranking algorithm that considers additional variables). This system of Business Process Allocation 1.4.3 lays the foundation for systematic assignment of large volumes of tasks relative to the Mass Action Litigation type through the Tech component 1.5 and its Resource Allocation sub-component 1.5.9, thus enabling the efficiencies that permit the National Legal System to meet a market need in the area of high volume, relatively low value legal disputes. Tech Component 1.5.

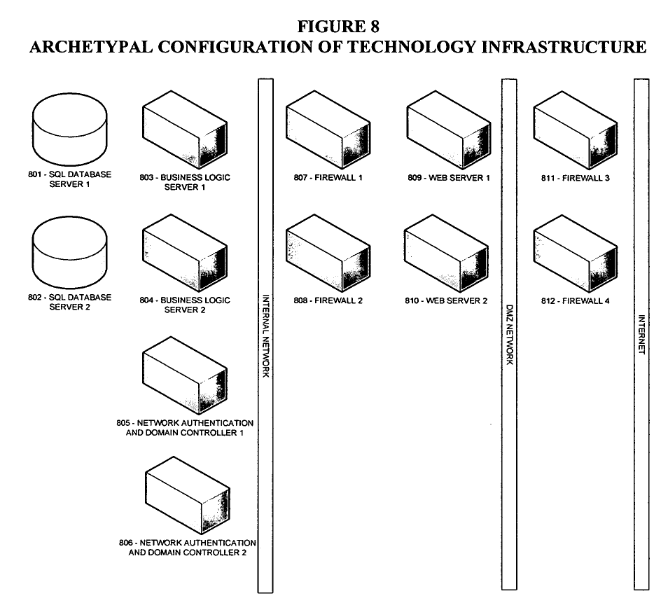

The Tech component 1.5 encapsulates the automated data systems that bind the policies, processes, and procedures dictated by the Efficacy component 1.4 to automated, systematic processing routines and human workers 1.1, 1.2 selected through Business Process Allocation. The computer technology described is necessary for operation of the National Legal System; however, the technology is readily supplied through commercially available computer systems. The technology described follows the N-Tier architecture model, presuming that the data store, logic components, and user interface will be developed following this best practices model. An archetypal configuration of the technology infrastructure required is shown in FIG. 8. The principal requirements of the technology infrastructure are described as follows:

Single Data Store Sub-Component 1.5.1.

It is essential that the operator of the National Legal System establish and maintain a single primary data store 801, 802 following industry standard database design and administration principles. It is critical that the primary data store 801, 802 have a high level of transactional consistency, as the primary data store 801, 802 will ordinarily be accessed by a widely distributed group of users, including many users over the Internet in most instances.

Redundancy and Disaster Recovery Sub-Component 1.5.2.

The primary data store 801, 802, and all other hardware and software components 801-812 comprising the data system used to operate the National Legal System, are operated in a redundant environment (e.g., 801 and 802 (which are redundant elements)) such that any hardware or software failure is easily corrected in a trivial amount of time. The environment includes a disaster recovery plan that has been tested. The disaster recovery plan provides for a hot back-up site.

System of Record Sub-Component 1.5.3.

The primary data store 801, 802 is configured with applicable security, audit logging, and control policies such that it is considered a system of record, meaning that an employee of the operator of the National Legal System with knowledge of the records maintained by the system can affirm under oath as to the veracity of those electronic records.

Process Based Workflow Sub-Component 1.5.4.

The core of the system necessary to operate the National Legal System is a rule based work flow engine that dynamically derives the workflow requirements relative to any specific claim at any specific time based on the type of claim and the jurisdiction relative to the claim using the hierarchical rule set produced through the application of Efficacy 1.4. (see supra, “Standardized Processes Sub-Component 1.4.1”). Further, the work flow engine 1.5.4 is capable of pushing tasks to the available pool of human workers through the user interface where required.

Each defined rule and its relevant attributes are stored in the primary data store 801, 802 for manipulation and processing by the workflow engine 1.5.4. Each component rule is bound to a workflow and each workflow has its finite set of inputs and outputs mapped completely. Inputs are both systematic; i.e., triggered from other processes, and manual. Outputs are likewise systematic and manual as required. The workflow engine 1.5.4 is encapsulated in a business logic server component 803, 804 separate and apart from the primary data store 801, 802.

The underlying component rules and workflows drive the Web Based User Interface sub-component 1.5.6, prompting the user to take the required action where appropriate and systematically taking the required action where appropriate. The user interface 1.5.6 in large part is a frame whose contents are configured by the applicable workflow. Every component rule of every workflow indicates the status of a particular claim, indicates the actions allowed as the next step, and produces a result when one of the permitted steps is taken.

Information Based Decision Making Sub-Component 1.5.5.

The system contemplates business intelligence concepts of information based decision making independent of the particular workflow relative to any given claim. Each claim is analyzed and prioritized based on some objective criteria. For example, if the operator of the National Legal System has determined that claims prosecuted in a particular jurisdiction are generally more favorable to plaintiffs relative to other jurisdictions, the claims in the more favorable jurisdiction are prioritized for work. All pending claims and all pending work are rank ordered by the Information Based Decision Making sub-component 1.5.5 using a priority queue structure. The Information Based Decision Making sub-component 1.5.5 is operated in the business logic server 803, 804.

Web Based User Interface Sub-Component 1.5.6.

The user interface is web based and accessible via the Internet 1.5.6. The user interface provides the user with aggregate information relative to the claims the user is processing and the particular information, embodied within the rules of the applicable workflow, of the particular claim the user is processing. The user interface 1.5.6 is minimalist, providing each user the information necessary to complete the given task and the aggregate information to properly manage assigned claims. In general, the user interface is, where possible, a “push interface”, presenting information to the user for decision making and then pushing the next set of relevant information after the user takes a permitted action. The user interface 1.5.6 is available in different forms to both the employees and contractors of the operator of the National Legal System and the plaintiffs utilizing the National Legal System (see supra, “Similarly Situated Plaintiffs Element”). The user interface 1.5.6 is hosted on web servers 809, 810.

Hierarchical Security Sub-Component 1.5.7.

Principles of hierarchical security are applied to users accessing the system 1.5.7. Any particular user has access only to those portions of the system required to fulfill the worker's particular job function and no more. When actions should be taken or must be considered that are outside the scope of a particular user's permissions, the decision is elevated to the next person in charge with the power and authority to make such decisions. Hierarchical security 1.5.7 is implemented across all layers of the system 801-812 and coordinated with network authentication and control 805, 805 via the Security Services sub-component.

Security Services Sub-Component 1.5.8.

The network hosting the system is deployed using best security practices. Periodic security audits are conducted by qualified third parties to assess security vulnerabilities. Authentication and control of network users is provided by the Network Authentication and Domain Controllers 805, 806.

Resource Allocation Sub-Component 1.5.9.

Just as the system has a workflow rules engine, it has a resource allocation engine 1.5.9. The resource allocation engine 1.5.9 is dedicated to allocating available workers to the priority work queue created by the Information Based Decision Making sub-component 1.5.5. The Resource Allocation sub-component 1.5.9 implements the filtering rules and ranking algorithm established by the Efficacy component 1.4 for Optimized Business Process Allocation 1.4.3. The Resource Allocation sub-component 1.5.9 tracks all the attributes related to each worker. Further, the Resource Allocation sub-component 1.5.9 tracks the available time of each worker. The Resource Allocation sub-component 1.5.9 operates in the business logic server 803, 804 as an encapsulated component.

Document Management Sub-Component 1.5.10.

The Document Management sub-component 1.5.10 stores all documents related to a particular claim and facilitates access to those documents available through the Web Based User Interface 1.5.6. The Document Management sub-component 1.5.10 implements security through the Hierarchical Security sub-component 1.5.7, thus only permitted users are allowed to access particular documents. The Document Management sub-component 1.5.10 is capable of storing documents generated in any format.

In addition, the Document Management sub-component 1.5.10 is capable of generating documents required for the processing of claims. The Document Management sub-component 1.5.10 stores document templates in a hierarchical fashion. The hierarchy mirrors the hierarchy of rules for a particular type of Mass Action Litigation established by the Efficacy component 1.4. Thus, the Document Management sub-component 1.5.10 generates documents starting from a base universal template, with subsequent overlying application of majority rule/minority rule templates and exception based jurisdiction specific templates. By utilizing a hierarchical template assembly methodology, the Document Management sub-component 1.5.10 automatically generates correct document templates specific to any particular claim.

Once a document template has been generated, the Document Management sub-component 1.5.10 merges the specific information relevant to a particular claim from the underlying primary data store 801, 802. The Document Management sub-component 1.5.10 is operated in the business logic server 803, 804.

Claim Flow Diagram FIG. 2

FIG. 2 presents an archetypal claim flow diagram. The Litigation Component Filter 1.3, 401 is shown on the diagram as 204. FIG. 2 is generic and could represent almost any Mass Action Litigation type. However, the following discussion is illustrative of the flows pertaining to consumer debt collection claims.

Once a claim is qualified and passes through 204, a supplementary data request and append operation 208 is carried out. Typically, this supplementary data request and append 208 is an operation whereby certain elements of the data submitted by the plaintiff are transmitted to third party data providers such as credit bureaus (e.g., Equifax) and/or other third party data providers such as Accurint and the bankruptcy notification service provided by Lexis-Nexis. These external data providers receive the data, append updated information, and return the supplemented data to the operator of the National Legal System. Typically, the appended data includes updated address information, updated telephone information, credit bureau information, and/or other types of consumer information.

Once the supplementary data append 208 is completed, the claims are stratified based on selected variables 209 for grouping into the Pre-Legal 220, Legal 230, Post-Judgment 240, Bankruptcy 250, Probate 260, and Exception 270 groups. As an example, a typical claim is placed into the Pre-Legal group 220, where a workflow contemplating a settlement of the dispute in advance of litigation is contemplated. A claim that is indicated to have a statute of limitations date approaching in the next sixty days, however, might immediately be grouped into the Legal group 230. A claim that is related to a particular defendant who has filed bankruptcy, according to the supplemental data append 208, is immediately grouped into the Bankruptcy group 260. The “selected variables” upon which this stratification 209 is based vary with the particular embodiment of the invention depending on the strategy selected by the operator of the National Legal System.

It should be noted that a return path 272 from the Exception group 270 is indicated as an entry point to the account grouping process 210, as upon the resolution of any exception routed through 272, the particular claim is queued for reprocessing via 210.

The six groups shown as Pre-Legal 220, Legal 230, Post-Judgment 240, Bankruptcy 250, Probate 260, and Exception 270 are the primary groups to which any claim proceeding through a Mass Action Litigation workflow are assigned. The purpose of each group is described hereafter.

The Pre-Legal group 220 and Pre-Legal Process 221, as indicated, ordinarily comprise the initial entry point of most claims (barring the existence of some variable that would assign the claim immediately into one of the other groups). The Pre-Legal group 220 contemplates a pre-litigation settlement of the claim. Typically, this process involves contacting the defendant for a particular instance of Mass Action Litigation by letter and/or telephone in an attempt to settle the claim. If the claim is settled, the claim terminates within 221. If an exception occurs to the defined Pre-Legal Process 221; e.g., the claim cannot be settled, or a designated period of time passes after the entry of the particular claim to the Pre-Legal Process 221, the claim proceeds to the exception check point 222.

At the exception check point 222, the claim is checked to determine if an exception exists to the defined process. If such an exception exists, the claim is transferred via the Aₓ entry points to either the Probate 250, Bankruptcy 260, or Exception 270 groups as appropriate (note that Probate 250 and Bankruptcy 260 are considered “Exceptions”, albeit defined exceptions). If an exception does not exist, the claim is checked to determine if the claim is settled 223. If the claim is settled 223, the claim is terminated 224. It should be noted that “settled” may be broadly defined; e.g., if the amount in controversy for a particular claim is less than $100 and the claim is not resolved in the Pre-Legal Process 221, it is deemed settled. If the claim is not settled, the claim proceeds to the next elevated process 225.

A particular claim originating from the Pre-Legal Process 221 is elevated to the next level process via 225; i.e., through the non-exception groups (Legal 230 and Post-Judgment 240), or in limited circumstances, from the Legal group 230 to the Pre-Legal group 220. A claim can never proceed from the Post-Judgment group 240 to the Pre-Legal group 220. An example of the limited circumstances whereby a claim may return from the Legal group 230 to the Pre-Legal group 220, is a claim in which the defendant agrees to settle while the claim is in the Legal Process 231 by making payments over a period of time. In this case, the claim might be returned to the Pre-Legal group 220 for monitoring of the settlement arrangement.

Ordinarily, a claim that is not resolved in the Pre-Legal group 220 proceeds to the Legal group 230 and Legal Process 231, via the entry point designated as “B.” In the Legal Process 231, the claim proceeds through a legal workflow particular to the Mass Action Litigation type, as has been defined by the Efficacy component (1.4). The Legal Process 231 typically encompasses preparing, filing, and serving a lawsuit for a particular instance of Mass Action Litigation. The Legal Process 231 itself is quite detailed, applying the relevant universal, majority, minority, and exception rules as appropriate. It contemplates the typical steps of the litigation process; e.g., the default judgment process, the consent judgment process, a complaint to which an answer is filed, etc. As with the Pre-Legal Process 221, after a designated time or upon the occurrence of an exception, a particular claim proceeds to an exception check point 232. The same type of queries as would be processed against a claim originating from the Pre-Legal Process 221 at this stage is also processed against an account originating from the Legal Process 231.

Barring an exception or settlement, a claim originating from the Legal Process 231 is then elevated to the next level process through 235. As indicated, in certain circumstances, a particular claim may return to the Pre-Legal group 220 and Pre-Legal Process 221, but ordinarily proceeds to the Post-Judgment group 240 and Post-Judgment Process via the entry point designated as “C.” This transition is predicated on whether a judgment has been entered relative to the particular claim.

The Post-Judgment group 240 is the last non-exception processing queue. Once a claim enters this queue, it is processed through a Mass Action Litigation type specific post-judgment workflow, applying universal 5.1, majority 5.1.1, minority 5.1.2, and exception 5.1.3 rules in the Post-Judgment Process 241. The process ordinarily entails a variety of different steps; e.g., prosecuting a garnishment action, recording a lien, pursuing post-judgment discovery, etc. Upon the occurrence of an exception or after a designated time period expires, a claim proceeds from the Post-Judgment Process 241 to the exception check point 242 and then to 243, checking respectively for an exception or settlement. If the claim is not resolved in the Post-Judgment Process 241 within the designated time, the claim is terminated at 244, with no further action taken (although claims that ultimately proceed to this warehouse of dead claims could ultimately be reactivated after a period of time and reprocessed through the Post-Judgment group 240).

The Probate 250, Bankruptcy 260 and Exception 270 groups all represent exception processes, and the majority of claims are never processed through one of these processes. An alternative embodiment of the invention, however, might be operated exclusively to service claims that would be grouped in the Probate 250, Bankruptcy 260, or Exception 270 groups.

The Probate group 250 has two entry points, one directly from 210, and an entry point designated as A_{A}, which is the entry point for claims originating from either the Pre-Legal exception check point 222, the Legal exception check point 232, or the Post-Judgment exception check point 242. The Probate Process 251 contemplates the resolution of claims where the defendant is deceased. In this process, the claim is no longer against the defendant; it is against the defendant's estate. As a result, claims where this condition is true are processed separately, as a distinct court system and set of rules exists for this type of claim. Thus, the Probate Process 251 contemplates a detailed workflow that is Mass Action Litigation type specific and applies universal 5.1, majority 5.1.1, minority 5.1.2, and exception 5.1.3 rules in the same manner as the Pre-Legal Process 221, Legal Process 222, and Post-Judgment Process 223 workflows. Like any claim processed in the Pre-Legal 220, Legal 230, and Post-Judgment 240 groups, a claim processed through the Probate group 250 proceeds to the next step in the workflow upon the occurrence of an exception or after a designated period of time. Thus, exception resolution for claims in the Probate group is addressed at 252. An account may proceed either to the Bankruptcy group 260 or the Exception group 270 from the Probate group exception check point 252. Exits from the Probate group 250 flow via the exception checking process 252 and are designated and linked to a corresponding entry point on the referenced groups. The Probate group 250 contemplates that if a claim is not resolved in the designated time, it is deemed resolved and terminated via 254. There is no escalation flow ending the Probate group 250 flow.

The Bankruptcy group 260 has two entry points as well, one directly from 210, and an entry point linked to the Pre-Legal exception check point 222, the Legal exception check point 232, the Post-Judgment exception check point 242, and the Probate exception check point 252. The Bankruptcy Process 261 contemplates resolution of claims where the defendant has filed bankruptcy. In this process the claim is still pursued against the defendant; however, the claim is pursued through an intermediary, namely, the bankruptcy court and trustee. As a result, claims where this condition is true are processed separately, as a distinct court system and set of rules exists for this type of claim. Thus, the Bankruptcy Process 261 contemplates a detailed workflow that is Mass Action Litigation type specific and applies universal 5.1, majority 5.1.1, minority 5.1.2, and exception 5.1.3 rules in the same manner as the Pre-Legal Process 221, Legal Process 231 and Post-Judgment Process 241 workflows. Like any claim processed in the Pre-Legal 220, Legal 230 and Post-Judgment 240 groups, a claim processed through the Bankruptcy group 260 proceeds to the next step in the workflow upon the occurrence of an exception or after a designated period of time. Thus, exception resolution for claims in the Bankruptcy group 260 is addressed at the Bankruptcy exception check point at 262. An account may proceed either to the Probate group 250 or the Exception group 270 from the Bankruptcy group 260 exception check point. Exits from the Bankruptcy group 260 workflow via the exception checking process 262 are designated and linked to a corresponding entry point on the referenced groups. The Bankruptcy group 260 contemplates that if a claim is not resolved in the designated time, it is deemed to be resolved and terminated 264. There is no escalation flow ending the Bankruptcy group 260 flow.

The Exceptions group 270 has two entry points, one directly from 210, and an entry point that is linked to the Pre-Legal exception check point 222, the Legal exception check point 232, the Post-Judgment exception check point 242, the Probate exception check point 252, and the Bankruptcy exception check point 262. The Exceptions Process 271 contemplates resolution of claims that do not otherwise fall within the scope of the other defined groups. This may occur, for example, when the defendant relative to a particular claim initiates a claim with the plaintiff based on the alleged fact that the claim is fraudulent. The Exceptions Process 271 is a loop. The only exit from the Exceptions Process is via 272, which, once the exception is resolved, returns the claim to 210.

FIG. 2 presents one potential embodiment of an archetypal claim flow diagram that is capable of processing most types and instances of Mass Action Litigation. The underlying detailed specifications presumed by FIG. 2 are in some instances defined as a matter of law and in some instances as a matter of strategy. It is anticipated that the examples highlighted are typical of the patterns that would emerge from an examination of similar claim flows from operational instances of the invention.

Cross Functional Diagram Of National Legal System And Archetypal claim Flow FIG. 3

FIG. 3 presents a cross functional diagram showing the interaction of the National Legal System (FIG. 1) and the National Legal System Archetypal claim Flow (FIG. 2). FIG. 3 shows which component of the National Legal System completes the work shown in FIG. 2. FIG. 3 is numbered consistently with FIG. 2, excepting those instances where a component or process not shown on FIG. 2 is shown on FIG. 3.

All processes identified in 201-210 on FIG. 2 are shown in FIG. 3 as occurring in the Tech component 1.5 of the National Legal System. All claims selected for processing are shown split into the relevant defined groups Pre-Legal 220, Legal 230, Post-Judgment 240, Probate 250, Bankruptcy 260, and Exceptions 270 in the Back Office component 1.1 of the National Legal System. Each claim proceeds first to the relevant process for its selected group in the Back Office component 1.1. Each claim is then divided into the steps called for by the relevant group (Pre-Legal 220, Legal 230, Post-Judgment 240, Probate 250, Bankruptcy 260, and Exceptions 270) and allocated between the Back Office component 1.1 and the Attorneys component 1.2 as required by the Resource Allocation sub-component 1.5.9, 302 of the Tech component 1.5 (which is defined by the Business Process Allocation sub-component 1.4.3, 302 of the Efficacy component 1.4). The results of the work completed by the Back Office 1.1 and Attorney 1.2 components may produce results and interactions with external third parties (e.g., courts and defendants), which are shown as occurring in the Litigation component 1.3 on FIG. 3.

We claim:

1. A system for processing litigation on a jurisdictionally dispersed basis using workers having different types of expertise, the system comprising:
a. A first database for storing a plurality of records, each corresponding to a legal dispute, each of the plurality of records including data representing:
i. A plaintiff associated with the legal dispute;
ii. A defendant associated with the legal dispute;
iii. A jurisdiction associated with the legal dispute;
b. A second database for storing a plurality of workflows associated with the records of the first database;
c. A processor for:
i. Transmitting a selected one of the plurality of records to a selected attorney, the selected record including data representing a selected plaintiff, a selected defendant and a selected jurisdiction, whereby the selected attorney initiates litigation on behalf of the selected plaintiff against the selected defendant in the selected jurisdiction;
ii. Pushing administrative tasks from a selected workflow, associated with the selected record, that do not require legal representation to one or more specialized non-attorney workers trained to perform such tasks, whereby the one or more specialized non-attorney workers complete the administrative tasks; and
iii. Pushing legal tasks from the selected workflow that requires legal representation to the selected attorney, whereby the selected attorney completes the legal tasks.

2. The system of claim 1, wherein the processor continues functions ii and iii until the selected workflow is completed.

3. The system of claim 1, wherein the class of each legal dispute is common among all records in the first database.

4. The system of claim 1, wherein the selected attorney is licensed to practice law within the selected jurisdiction.

5. The system of claim 1, wherein the legal disputes corresponding to each record in the first database have a relatively low value.

6. The system of claim 1, wherein the legal disputes corresponding to each record in the first database all are associated with a narrow legal area.

7. The system of claim 1, wherein the plaintiffs represented in the plurality of records in the first database are all similarly situated.

8. The system of claim 1, wherein the defendants represented in the plurality of records in the first database are all similarly situated.

9. The system of claim 1, wherein the legal disputes corresponding to each record in the first database all relate to a common set of facts.

10. The system of claim 1, wherein the administrative tasks are selected from a group consisting of: financial services, legal support services, IT support services and legal management services.

11. The system of claim 1, wherein the legal tasks are selected from a group consisting of: pre-legal, legal, post-judgment, probate and bankruptcy.

12. The system of claim 1, wherein the administrative tasks pushing function is performed through a web portal.

13. The system of claim 12, wherein the one or more specialized non-attorney workers indicate completion of the administrative tasks through the web portal.

14. The system of claim 1, wherein the legal tasks pushing function is performed through a web portal.

15. The system of claim 14, wherein the selected attorney indicates completion of the legal tasks through the web portal.

16. The system of claim 1, wherein the jurisdictions represented in the plurality of records in the first database span multiple states.

17. The system of claim 1, wherein the processor pushes the administrative tasks to one or more specialized non-attorney workers based upon availability.

18. The system of claim 1, wherein the processor pushes the administrative tasks to one or more specialized non-attorney workers based upon skill set.

19. The system of claim 1, wherein the processor pushes the administrative tasks to one or more specialized non-attorney workers based upon cost.

20. The system of claim 1, wherein the plurality of workflows are dynamically generated using prescribed rules associated with the corresponding legal disputes and jurisdictions.

21. A system for processing litigation on a jurisdictionally dispersed basis using workers having different types of expertise, the system comprising:
a. A first database for storing a plurality of records, each corresponding to a legal dispute, each of the plurality of records including data representing:
i. A plaintiff associated with the legal dispute;
ii. A defendant associated with the legal dispute;
iii. A jurisdiction associated with the legal dispute;
b. A second database for storing a plurality of workflows associated with records of the first database;
c. A processor for:
i. Transmitting a selected one of the plurality of records to a first selected attorney, the selected record including data representing a selected plaintiff, a selected defendant and a selected jurisdiction, whereby the first selected attorney initiates litigation on behalf of the selected plaintiff against the selected defendant in the selected jurisdiction;
ii. Pushing administrative tasks from a selected workflow, associated with the selected record, that do not require legal representation to one or more specialized non-attorney workers trained to perform such tasks, whereby the one or more specialized non-attorney workers complete the administrative tasks; and
iii. Pushing legal tasks from the selected workflow that requires legal representation to a second selected attorney, whereby the second selected attorney completes the legal tasks.

22. The system of claim 21, wherein the processor continues functions ii and iii until the workflow is completed.

23. The system of claim 21, wherein the first selected attorney and the second selected attorney perform their associated functions as a single law firm.

24. A method for processing litigation on a jurisdictionally dispersed basis using workers having different types of expertise, the method comprising:
a. Storing in a first database a plurality of records, each corresponding to a legal dispute, each of the plurality of records including data representing:
i. A plaintiff associated with the legal dispute;
ii. A defendant associated with the legal dispute;
iii. A jurisdiction associated with the legal dispute;
b. Storing in a second database a plurality of workflows associated with the records of the first database;
c. Transmitting a selected one of the plurality of records to a selected attorney, the selected record including data representing a selected plaintiff, a selected defendant and a selected jurisdiction, whereby the selected attorney initiates litigation on behalf of the selected plaintiff against the selected defendant in the selected jurisdiction;
d. Pushing administrative tasks from a selected workflow, associated with the selected record, that do not require legal representation to one or more specialized non-attorney workers trained to perform such tasks, whereby the one or more specialized non-attorney workers complete the administrative tasks; and
e. Pushing legal tasks from the selected workflow that require legal representation to the selected attorney, whereby the selected attorney completes the legal tasks.

25. The method of claim 24, wherein functions d and e are continued until the selected workflow is completed.

26. The method of claim 24, wherein the class of each legal dispute is common among all records in the first database.

27. The method of claim 24, wherein the selected attorney is licensed to practice law within the selected jurisdiction.

28. The method of claim 24, wherein the legal disputes corresponding to each record in the first database have a relatively low value.

29. The method of claim 24, wherein the legal disputes corresponding to each record in the first database all are associated with a narrow legal area.

30. The method of claim 24, wherein the plaintiffs represented in the plurality of records in the first database are all similarly situated.

31. The method of claim 24, wherein the defendants represented in the plurality of records in the first database are all similarly situated.

32. The method of claim 24, wherein the legal disputes corresponding to each record in the first database all relate to a common set of facts.

33. The method of claim 24, wherein the administrative tasks are selected from a group consisting of: financial services, legal support services, IT support services and legal management services.

34. The method of claim 24, wherein the legal tasks are selected from a group consisting of: pre-legal, legal, post-judgment, probate and bankruptcy.

35. The method of claim 24, wherein the administrative tasks pushing function is performed through a web portal.

36. The method of claim 35, wherein the one or more specialized non-attorney workers indicate completion of the administrative tasks through the web portal.

37. The method of claim 24, wherein the legal tasks pushing function is performed through a web portal.

38. The method of claim 37, wherein the selected attorney indicates completion of the legal tasks through the web portal.

39. The method of claim 24, wherein the jurisdictions represented in the plurality of records in the first database span multiple states.

40. The method of claim 24, wherein the administrative tasks are pushed to one or more specialized non-attorney workers based upon availability.

41. The method of claim 24, wherein the administrative tasks are pushed to one or more specialized non-attorney workers based upon skill set.

42. The method of claim 24, wherein the administrative tasks are pushed to one or more specialized non-attorney workers based upon cost.

43. The method of claim 24, wherein the plurality of workflows are dynamically generated using prescribed rules associated with the corresponding legal disputes and jurisdictions.

44. A method for processing litigation on a jurisdictionally dispersed basis using workers having different types of expertise, the method comprising:
a. Storing in a first database a plurality of records, each corresponding to a legal dispute, each of the plurality of records including data representing:
i. A plaintiff associated with the legal dispute;
ii. A defendant associated with the legal dispute;
iii. A jurisdiction associated with the legal dispute;
b. Storing in a second database a plurality of workflows associated with records of the first database;
c. Transmitting a selected one of the plurality of records to a first selected attorney, the selected record including data representing a selected plaintiff, a selected defendant and a selected jurisdiction, whereby the first selected attorney initiates litigation on behalf of the selected plaintiff against the selected defendant in the selected jurisdiction;
d. Pushing administrative tasks from a selected workflow, associated with the selected record, that do not require legal representation to one or more specialized non-attorney workers trained to perform such tasks, whereby the one or more specialized non-attorney workers complete the administrative tasks; and
e. Pushing legal tasks from the selected workflow that require legal representation to a second selected attorney, whereby the second selected attorney completes the legal tasks.

45. The method of claim 44, wherein functions d and e are continued until the workflow is completed.

46. The method of claim 44, wherein the first selected attorney and the second selected attorney perform their associated functions as a single law firm.
